(19) United States
(12) Patent Application Publication
(10) Pub. No.: US 2018/0360088 A1
(43) Pub. Date: Dec. 20, 2018

(54) METHOD FOR IMPROVING THE QUALITY OF HIGH-MOISTURE TEXTURIZED PEANUT PROTEIN BY TG ENZYME

(71) Applicant: Institute of Food Science and Technology, Chinese Academy of Agricultural Sciences, Beijing (CN)

(72) Inventors: Qiang WANG, Beijing (CN); Li LIU, Beijing (CN); Jinchuang ZHANG, Beijing (CN); Song ZHU, Beijing (CN); Hongzhi LIU, Beijing (CN); Aimin SHI, Beijing (CN); Hui HU, Beijing (CN)

(21) Appl. No.: 15/792,010

(22) Filed: Oct. 24, 2017

(30) Foreign Application Priority Data
Jun. 15, 2017 (CN) 201710452678.7

(51) Int. Cl. A23L 33/105; A23P 30/20; A23J 1/14; A23J 3/14; A23L 25/00

(52) U.S. Cl. CPC A23L 33/105; A23P 30/20; A23V 2002/00; A23J 3/14; A23L 25/30; A23J 1/14

(57) ABSTRACT

A method for improving the quality of high-moisture texturized peanut protein (TPP) by TG enzyme is provided. The method includes crushing low-temperature defatted peanut protein powder and mixing it with the TG enzyme, performing an extrusion texturization treatment, and obtaining the product after extrusion molding is cooled to yield the high-moisture TPP. The high-moisture TPP produced by the method has bright white color, fragrant taste, smooth surface, abundant fibrous structure and high fiber strength, and it can be used as a substitute for high-grade meat in the manufacturing of vegetarian beef and the like. The method significantly increases the degree of fibrosis of the high-moisture TPP, enhances the fiber strength, and broadens its application channels.

### TECHNICAL FIELD

The present invention relates to a method for improving the quality of high-moisture texturized peanut protein (TPP) by TG enzyme.

### BACKGROUND ART

The use of extrusion technology in food production has a history of more than 70 years, wherein the production of texturized vegetable protein (TVP) using the vegetable proteins such as soybean protein, peanut protein, gluten protein, whey protein and the like as the main raw materials is an important application of the extrusion technology in the food industry. The TVP produced by the extrusion method has excellent functional properties such as water absorption, oil absorption and the like, a cholesterol content of zero, a biological value of 93% to 97% after digestion and absorption in human body, and a function of preventing “modern civilization diseases” such as hypertension, obesity, cardiovascular and cerebrovascular diseases and the like; and it can be used as additive of meat products or meat analogues for consumption. The TVP can be divided into high-protein TVP (the protein content is more than 70%) and low-protein TVP (the protein content is between 50% and 55%) according to the protein content in raw materials; can be divided into low-moisture TVP (moisture content less than 35%) and high-moisture TVP (moisture content more than 45%) according to the moisture content; and can be divided into ordinary TVP (having a small amount of fibrous structures) and fibrous TVP (having an obvious fibrous structure) according to the fibrous structure of the products. Low-moisture TVP is the main product form in the international and domestic markets, and mainly texturized soybean protein (TSP); however, high-moisture TVP is a kind of new product, and based on the analysis of its organizational structure and texture, it has more excellent properties as compared with the puffed products, which is an upgrading product of the puffed products.

The TPP as compared with the TSP has more advantages such as bright wight color and unique flavor and the like, but its fibrous structure is still poor. TG enzymes can catalyze the cross-linking reaction between the protein molecules, and improve many important properties of proteins. When the enzyme is used for the production of restructured meat, it can not only make the minced meat bonded together, but also make a variety of non-meat protein cross-linked to the meat protein, which can significantly improve the mouthfeel, flavor, organizational structure and nutrition of the meat products, and improve the nutritional value of protein. Moreover, TG enzymes can make the essential amino acids (such as lysine) covalent cross-linked to the protein, prevent the destruction of amino acids from Maillard reaction; and improve the nutritional value of protein.

Chinese Patent Application No. 200810137299.X titled “Method for producing TSP by using high-temperature defatted soybean meals as raw material” discloses a method for producing TSP by using high-temperature defatted soybean meals as raw material. The biological enzymolysis technology in the invention is used to activate the high-temperature defatted soybean meals, so as to increase the nitrogen solubility index and improve the texturizing or fibrosis effect of the protein. But the biological enzymolysis technology is mainly for the seriously degenerated protein material, and bitterness is easily produced during the hydrolysis process, which is not conducive to consumption. Chinese Patent (Publication No. CN101889627A) titled “Method for producing ready-to-eat meat analogues by using soybean protein isolate” discloses a method for producing high-moisture TSP by adding soybean polysaccharide into soybean protein isolate. However, the additive amount of the polysaccharide is more than 20%, which does not meet the healthy-eating habits, especially for a patient suffered with diabetes. Chinese Patent Application No. CN201010203086.X titled “Preparation technology of fibrous TVP” discloses a method for preparing puffed fibrous TPP by using the medium degeneration low-fat peanut protein powder as raw material. However, the moisture content of the protein is only about 25%, and the nutrients in peanuts have been seriously destroyed in the subsequent high temperature drying. Its products need to be rehydrated in the subsequent application, which can only be used as the additives for meat products.

In view of this, the present invention has been proposed.

### SUMMARY OF THE INVENTION

The purpose of the present invention is to provide a method for improving the quality of high-moisture TPP by TG enzyme and the produced high-moisture TPP.

The technical solutions of the invention are as follows:

A method for improving the quality of high-moisture TPP by TG enzyme, comprising the following steps:

1) low-temperature defatted peanut protein powder is crushed, and then mixed well with the TG enzyme in an appropriate amount;

the additive amount of TG enzyme is 0 to 2% by weight of the low-temperature defatted peanut protein powder.

Preferably, the additive amount of TG enzyme is 0.09% to 1% by weight of the low-temperature defatted peanut protein powder.

More preferably, the additive amount of TG enzyme is 0.18% to 0.5% by weight of the low-temperature defatted peanut protein powder.

In a specific embodiment of the present invention, the additive amount of TG enzyme is 0.3% by weight of the low-temperature defatted peanut protein powder.

In a specific embodiment of the present invention, the additive amount of TG enzyme is 0.09% by weight of the low-temperature defatted peanut protein powder.

The TG enzyme of the present invention is transglutaminase.

2) Extrusion process: the material obtained in step 1) is subjected to an extrusion texturization treatment (for example, using a screw extruder), wherein extrusion temperatures are as follows: 60° C. to 80° C. (the temperature of the feeding zone of the extruder barrel), 80° C. to 100° C. (the temperature of the mixing zone), 130° C. to 160° C. (the temperature of the melting zone), 90° C. to 130° C. (the temperature of the cooling die), and 50° C. to 90° C. (the temperature of the molding zone); water is added online during extrusion to adjust the moisture content of the material, so that water and the material are mixed well in the barrel, and the moisture content of the material during extrusion is 45% to 65% (mass fraction); the product obtained after extrusion is cooled to give the high-moisture TPP with obvious fibrous structure.

Further, in order to achieve thorough mixing of the materials (low-temperature defatted peanut protein powder and TG enzyme) and sufficient contact between the material molecules, and facilitate the subsequent extrusion texturization treatment to form the high-moisture TPP, the low-temperature defatted peanut protein powder is preferably crushed into small particles, and sieved by a 60 to 80 mesh sieve. Furthermore, the mixed material may be loaded into a sealed container, and equilibrated for a period of time. The equilibration time may generally be 20 to 30 hours, for example 24 hours.

A mixer can be used in step 1) for fully chopping and mixing the materials.

Further, the extrusion temperatures in step 2) are as follows: 60° C. to 70° C. (the feeding zone), 90° C. to 100° C. (the mixing zone), 140° C. to 160° C. (the melting zone), 100° C. to 130° C. (the cooling die), and 60° C. to 80° C. (the molding zone).

In a specific embodiment of the present invention, the extrusion temperatures are as follows: 70° C. (the feeding zone), 95° C. (the mixing zone), 145° C. (the melting zone), 120° C. (the cooling die), and 80° C. (molding zone).

In a specific embodiment of the present invention, in step 2), the moisture content of the material during extrusion is adjusted to 58% (mass fraction).

Further, the screw rotation speed is 180 to 250 r/min and the feeding speed is 120 to 160 g/min during the extrusion of step 2); preferably, the screw rotation speed is 180 to 210 r/min and the feeding speed is 140 to 160 g/min. In a specific embodiment of the present invention, the screw rotation speed is 200 r/min and the feeding speed is 150 g/min.

Further, the above-mentioned method for improving the quality of high-moisture TPP by TG enzyme further comprises the step of cutting and cooling the extrusion molded material after the extrusion texturization treatment, for example, cutting the material extruded from the extruder into 15 to 20 cm, to obtain the high-moisture TPP. The cut high-moisture TPP is loaded into a vacuum packaging bag, which is vacuumized, sealed and then cooled in a fluidized bed.

The extrusion texturization treatment according to the present invention may be carried out by using a twin-screw extruder.

Preferably, the screw assembly mode of the twin-screw extruder used in the present invention is a high shear combination in which a kneading block with a shear angle of 45° is selected as a screw shear element; there are four shear sections; and the screw shear elements and the delivery elements are installed on a screw with a length-diameter ratio of 24:1 alternately.

Preferably, the cooling is carried out by passing the extrusion molded material obtained after the extrusion texturization treatment through a molding zone having a length of about 1 m, a width of about 80 cm and a height of about 3 cm to obtain the high-moisture TPP. Further, the temperature of the molding zone is 60° C. to 80° C.

Further, the low-temperature defatted peanut protein powder according to the present invention has a crude protein content equal to or more than 55%, and a crude fat content equal to or less than 7%. The present invention also comprises the high-moisture TPP prepared by the method described above.

The present invention also comprises the application of the above-mentioned high-moisture TPP in food processing.

The high-moisture TPP according to the present invention can be used for producing the food such as semi-finished products, for example, “vegetarian chicken dices” which are used as garnish of Kung Pao Chicken, barbecued meat, chaffy dish meat, and meat pie for fast food, and end products, for example, vegetarian protein meat, pulled meat, vegetarian sausage, vegetarian pork and the like.

The high-moisture TPP obtained according to the present invention improves the beany flavor of products prepared using soybeans as raw materials, and overcomes the problem that it is difficult to prepare high-moisture TPP; and the product does not need rehydration any more. The high-moisture TPP has a good taste with no bean flavor, natural color, uniformity with no charring color, rich nutrient and better flavor.

The high-moisture TPP according to the invention has a bright white color, a smooth surface, a soft texture, a fragrant taste, and a feature of ready-to-eat, which is similar to the high-moisture TSP. The high-moisture TPP has an obvious fibrous structure, and its texturizing degree is 1.2 to 1.6, fiber strength is 1.5 to 2.0 kg, elasticity is 0.85 to 1.0, hardness is 25 to 35 kg, and chewiness (×10³) is 13 to 20.

Further, the moisture content of the high-moisture TPP according to the present invention is 50% to 60%.

The texturizing degree, fiber strength, elasticity, hardness, and chewiness can be detected by the methods commonly used in the art.

The high-moisture TPP according to the present invention can be used as a substitute for meat in the manufacture of chicken dices, pulled meat, vegetarian sausage and the like. The method according to the present application has the following advantages: full utilization of raw materials, almost no waste emission, continuous production, high process integration level, and low energy consumption, and it is conducive to improving the additional value of peanut protein powder.

The raw materials of the present invention are commercially available.

The present invention has the following beneficial effects:

(1) the TG enzyme used in the invention has the characteristics of high efficiency, less dosage and low cost;

(2) the moisture content of the material during extrusion can be up to 60% or more, and the high-moisture TPP is rich in fibrous structure and has high fiber strength; the method increases the texturizing degree of the high-moisture TPP, enhances the fiber strength, and broadens its application channels;

(3) the product has a high nutritional value; and

(4) the product has rich flavor, attractive color, smooth surface, and good taste.

### BRIEF DESCRIPTION OF THE DRAWINGS

FIG. 1 is a process flow diagram of the method according to the present invention.

FIG. 2a is an internal structure diagram of the high-moisture TPP obtained by Comparative Example 3.

FIG. 2b is an internal structure diagram of the high-moisture TPP modified with TG enzyme of Example 1.

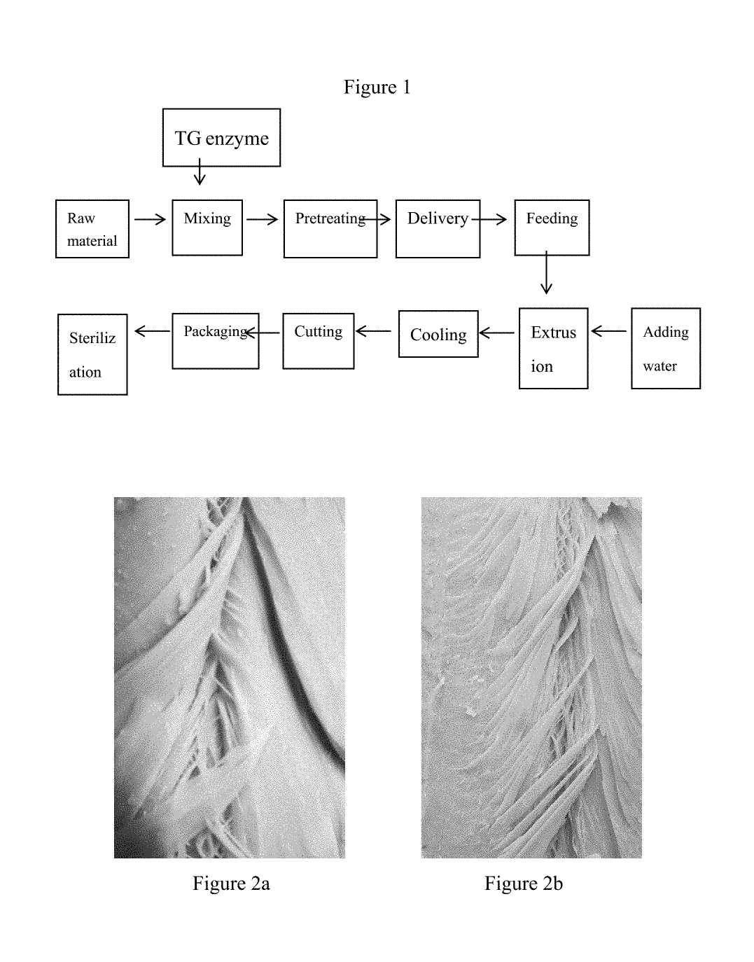

### SPECIFIC MODES FOR CARRYING OUT THE EMBODIMENTS

The following examples are intended to illustrate the present invention, but are not intended to limit the scope of the present invention. The operations involved in the examples are conventional technical operations in the art, unless otherwise specified. The implementation conditions in the examples may be further adjusted according to specific experimental conditions or plant conditions, and conditions that are not specified are generally conditions used in conventional experiments.

The following extrusion texturization treatments are carried out by using FMHE36-24 twin screw extruder.

The following texturizing degree, fiber strength, elasticity, hardness, chewiness, color, specific mechanical energy (SME) were detected by the methods recited in references such as Li Shujing (2014), Zhang Bo (2010), Zhang Cuan (2007) and the like (see reference).

The low-temperature defatted peanut protein powder used below was purchased from Qingdao Changshou Food Co., Ltd., and the basic physical and chemical properties were shown as follows:

| Crude protein content | Crude fat | |
|---|---|---|
| % (×5.46 dry basis) | content % (dry basis) | Moisture % |
| 60.75 ± 0.748 | 6.95 ± 0.044 | 5.82 ± 0.057 |

The TG enzyme mentioned below was purchased from Beijing Solaibao Technology Co., Ltd.

### Example 1

A method for improving the quality of high-moisture TPP by TG enzyme, comprising the following steps:

(1) crushing raw material: the low-temperature defatted peanut protein powder was crushed into small particles, and was sieved by a 60 to 80 mesh sieve, and then taken 5 kg for use;

(2) pre-mixing the raw materials: the crushed peanut protein powder and TG enzyme in an amount of 0.3% by weight of the peanut protein powder were mixed in the mixer for 2 to 10 min, and equilibrated for 20 h to 24h;

(3) assembling screw elements: high shear combination, that is, a kneading block with a shear angle of 45° was selected as a screw shear element, and the assembled screw was placed into the extruder barrel and fixed firmly;

(4) pre-heating the extruder: a twin-screw extruder was preheated after start of the extruder, the temperature of the feeding zone of the extruder barrel was as follows: 70° C. in the feeding zone, 95° C. in the mixing zone, 145° C. in the melting zone, 120° C. at the cooling die, and 80° C. in the molding zone; the screw rotation speed was adjusted to 200 r/min, and the feeding speed was 150 g/min;

(5) adjusting the moisture content of the material: water was added online during extrusion, so that water and the material were mixed well in the barrel, and the final moisture content of the material was 58% by mass;

(6) extrusion molding: after adjustment of the moisture content, the material was extrusion molded in the extruder and then passed through a molding zone having a length of about 1 m, a width of about 80 cm and a height of about 3 cm to give the high-moisture TPP;

(7) cutting: the extruded high-moisture TPP was cut into long strips with a length of about 20 cm by a hydraulic cutter at the outlet of the extruder; and

(8) packaging: long strips of the high-moisture TPP were quickly packaged with a vacuum bag, and stored in a refrigeration storage at 4° C.

The detection results of the high-moisture fibrous texturized peanut protein prepared in this example were as follows:

| | | | | | | Unit |
|---|---|---|---|---|---|---|
| | | | | | | mechanical |
| | | | | | | energy |
| Textur- | Fiber | | | | Chew- | consumption |
| izing | strength | | Hardness | Color | iness | (SME)/ |
| degree | (kg) | Elasticity | (kg) | ΔE | (×10³) | (kJ · kg⁻¹) |
| 1.53 | 2.12 | 0.88 | 34.19 | 27.75 | 19.44 | 465.19 |

### Example 2

A method for improving the quality of high-moisture TPP by TG enzyme, wherein the specific operation steps thereof were the same as that in Example 1 except that in step (2), the additive amount of TG enzyme was 0.09%.

The detection results of the high-moisture TPP prepared in this example were as follows:

| | | | | | | Unit |
|---|---|---|---|---|---|---|
| | | | | | | mechanical |
| | | | | | | energy |
| Textur- | Fiber | | | | Chew- | consumption |
| izing | strength | | Hardness | Color | iness | (SME)/ |
| degree | (kg) | Elasticity | (kg) | ΔE | (×10³) | (kJ · kg⁻¹) |
| 1.21 | 1.81 | 0.85 | 25.21 | 26.58 | 13.39 | 472.43 |

### Comparative Example 1

A method for improving the quality of high-moisture TPP by TG enzyme, wherein the specific operation steps thereof were the same as that in Example 1 except that in step (2), the additive amount of TG enzyme was 0.025%.

The detection results of the high-moisture TPP prepared in this comparative example were as follows:

| | | | | | | Unit |
|---|---|---|---|---|---|---|
| | | | | | | mechanical |
| | | | | | | energy |
| Textur | Fiber | | | | Chew- | consumption |
| izing | strength | | Hardness | Color | iness | (SME)/ |
| degree | (kg) | Elasticity | (kg) | ΔE | (×10³) | (kJ · kg⁻¹) |
| 1.03 | 0.76 | 0.88 | 29.14 | 27.35 | 16.13 | 473.13 |

### Comparative Example 2

A method for improving the quality of high-moisture TPP by TG enzyme, wherein the specific operation steps thereof were the same as that in Example 1 except that in step (2), the additive amount of TG enzyme was 1%.

The detection results of the high-moisture TPP prepared in this comparative example were as follows:

| | | | | | | Unit |
|---|---|---|---|---|---|---|
| | | | | | | mechanical |
| | | | | | | energy |
| Textur- | Fiber | | | | Chew- | consumption |
| izing | strength | | Hardness | Color | iness | (SME)/ |
| degree | (kg) | Elasticity | (kg) | ΔE | (×10³) | (kJ · kg⁻¹) |
| 1.09 | 1.18 | 0.88 | 38.96 | 27.94 | 21.95 | 456.56 |

### Comparative Example 3

A preparation method of a high-moisture TPP, wherein the specific operation steps thereof were the same as that in Example 1 except that the raw materials did not include the TG enzyme.

The detection results of the high-moisture TPP prepared in this comparative example were as follows:

| | | | | | | Unit |
|---|---|---|---|---|---|---|
| | | | | | | mechanical |
| | | | | | | energy |
| Textur- | Fiber | | | | Chew- | consumption |
| izing | strength | | Hardness | Color | iness | (SME)/ |
| degree | (kg) | Elasticity | (kg) | ΔE | (×10³) | (kJ · kg⁻¹) |
| 0.97 | 0.47 | 0.91 | 33.04 | 27.96 | 18.82 | 455.34 |

The internal structures of the high-moisture TPP obtained in Comparative Example 3 and Example 1 were shown in FIGS. 2a and 2b, respectively. It can be seen that, the high-moisture TPP modified by the TG enzyme of Example 1 has more obvious fibrous structure, stronger fiber strength, more bright white color, high elasticity and chewiness.

The comparison results of the high-moisture TPP prepared in Examples 1-2 and Comparative Examples 1-3 were shown in Table 1:

TABLE 1
Comparison results

| | Property | | | | | | |
|---|---|---|---|---|---|---|---|
| | | Surface | Fibrosis | Fiber | | | |
| No. | Color | smoothness | degree | strength | Elasticity | Hardness | Chewiness |
| Example 1 | Bright | Relatively | Strong | Strong | Relatively | Relatively | Relatively |
| | white | smooth | | | strong | high | high |
| Example 2 | Bright | Relatively | Relatively | Relatively | Relatively | Relatively | Relatively |
| | white | smooth | strong | strong | strong | low | low |
| Comparative | Bright | Smooth | Relatively | Weak | Relatively | Relatively | Relatively |
| Example 1 | white | | weak | | strong | low | low |
| Comparative | Yellow- | Smooth | Relatively | Relatively | Relatively | High | high |
| Example 2 | white | | weak | weak | strong | | |
| Comparative | Yellow- | Relatively | Relatively | Weak | Relatively | Relatively | Relatively |
| Example 3 | white | smooth | weak | | strong | high | high |

### REFERENCES

1. L I Shujing. Study on relationship between thermal properties of raw materials and texture properties of extrusion texturized proteins [D]. Chinese Academy of Agricultural Sciences, 2014.
2. ZHANG Cuan. Study on peanut protein extrusion texturization technology and underlying mechanisms [D]. Northwest A & F University, 2007.
3. Zhang Bo. Characterization of the function of screws in a twin screw extruder [D]. Chinese Academy of Agricultural Sciences, 2010.

While the present invention has been described in detail by way of general description, specific embodiments and tests, it will be apparent to a person skilled in the art that based on the present invention, modifications and improvements may be made thereto without departing from the spirit and scope of the present invention. Accordingly, such modifications or improvements thar are made without departing from the spirit of the present invention are intended to be within the scope of the present invention.

1. A method for improving the quality of high-moisture texturized peanut protein (TPP by TG enzyme, wherein the method comprises the following steps:
1) low-temperature defatted peanut protein powder is crushed, and then mixed well with the TG enzyme in an appropriate amount;
wherein the additive amount of TG enzyme is 0 to 2% by weight of the low-temperature defatted peanut protein powder; and
2) an extrusion process is carried out, in which the material obtained in step 1) is subjected to an extrusion texturization treatment, and the extrusion temperatures are as follows: 60° C. to 80° C. in a feeding zone, 80° C. to 100° C. in a mixing zone, 130° C. to 160° C. in a melting zone, 90° C. to 130° C. in a cooling die, and 50° C. to 90° C. in a molding zone, wherein water is added online during the extrusion to adjust the moisture content of the material to 45% to 60%; and wherein the product obtained after the extrusion molding is cooled to give the high-moisture TPP.

2. The method according to claim 1, wherein, in step 1), the additive amount of TG enzyme is 0.09% to 1% by weight of the low-temperature defatted peanut protein powder; and/or
the low-temperature defatted peanut protein powder has a crude protein content of ≥55%, and a crude fat content of ≤7%.

3. The method according to claim 1, wherein, in step 1), the low-temperature defatted peanut protein powder is crushed into small particles, and sieved through 60 to 80 mesh sieve; or the method further comprises loading the mixed material into a sealed container, and equilibrating it for a period of time.

4. The method according to claim 1, wherein the extrusion temperatures in step 2) are as follows: 60° C. to 70° C. in the feeding zone, 90° C. to 100° C. in the mixing zone, 140° C. to 160° C. in the melting zone, 100° C. to 130° C. at the cooling die, and 60° C. to 80° C. in the molding zone; and/or
in step 2), the moisture content of the material during the extrusion is adjusted to 58%.

5. The method according to claim 1, wherein the screw rotation speed is 180 to 250 r/min and the feeding speed is 120 to 160 g/min during the extrusion of step 2).

6. The method according to claim 1, wherein the cooling is carried out by passing the extrusion molded material obtained after the extrusion texturization treatment through a molding zone having a length of about 1 m, a width of about 80 cm and a height of about 3 cm; and wherein the temperature of the molding zone is 50° C. to 80° C.

7. The method according to claim 1, wherein the extrusion texturization treatment is carried out by using a twin-screw extruder.

8. A high-moisture TPP prepared by the method according to claim 1.

9. A high-moisture TPP, wherein the protein has a texturizing degree of 1.2 to 1.6, a fiber strength of 1.5 to 2.0 kg, an elasticity of 0.85 to 1.0, a hardness of 25 to 35 kg, and a chewiness (×10³) of 13 to 20; and/or
a moisture content of 50% to 60%.

10. A use of the high-moisture TPP according to claim 8 in food processing.
